(19) United States
(12) Patent Application Publication
(10) Pub. No.: US 2014/0241510 A1
(43) Pub. Date: Aug. 28, 2014

(54) REMOTE CONTROLLER, REMOTE CONTROL SYSTEM, AND X-RAY SYSTEM INCLUDING THE SAME

(71) Applicant: GE Medical Systems Global Technology Company, LLC, Waukesha, WI (US)

(72) Inventors: Zhuying WANG, Beijing (CN); Yingjie JIA, Beijing (CN)

(73) Assignee: GE Medical Systems Global Technology Company, LLC, Waukesha, WI (US)

(21) Appl. No.: 14/193,591

(22) Filed: Feb. 28, 2014

(30) Foreign Application Priority Data
Feb. 28, 2013 (CN) 201210063017.7

(51) Int. Cl. H05G 1/02

(52) U.S. Cl. CPC H05G 1/02
USPC 378/197

(57) ABSTRACT

A remote controller, a remote control system and an X-ray system including the same. The remote control system includes a remote controller and a processing unit located in a controlled system controlled by the remote controller. The remote controller includes at least one key for a user to select a controlled object to be controlled via the remote controller, a sensing unit for sensing an orientation of the remote controller; and a wireless transmitter for transmitting to the controlled system which of the at least one key is selected by the user and orientation information of the remote controller sensed by the sensing unit. The processing unit generates a control command for the controlled system in accordance with information about the user's key selection and orientation information of the remote controller to control movement of a controlled object corresponding to the selected key in accordance with the remote control's orientation.

### TECHNICAL FIELD

The present invention relates to the field of X-ray imaging, and more particularly to a remote control system and a remote controller for controlling an X-ray system, and an X-ray system including the same.

### BACKGROUND ART

Most of the X-ray imaging systems have currently been equipped with a wireless remote controller designed to control movement, alignment and subsystem positioning of the X-ray bulb tube and the receiver, and the like. Typical positioning control includes rise and fall of the wall stand detector, upward and downward tilt of the wall stand detector, rise and fall of the sickbed, 5-axis movement and orientation of the overhead bulb tube support, and the like. Normally, the remote controller is generally provided with two independent keys for bidirectional motion control. For example, for the rise and fall controlling of the sickbed, one key is used to control the rising, and the other to control the falling. For controlling 5-axis movement of the overhead bulb tube support, more keys or push buttons may be needed. As such, problems may arise. Too many keys complicate the remote controller panel and increase the likelihood of mis-operations. In certain circumstances, movement toward a wrong direction may lead to security issues, such as collision or damage. In actual operations, a remote controller having less keys and easy to use is always desirable.

### SUMMARY OF THE INVENTION

According to one aspect of the present invention, there is provided a remote control system comprising a remote controller and a processing unit, the processing unit located in a controlled system controlled by the remote controller. The remote controller including: one or more keys for a user to select a controlled object to be controlled via the remote controller; a sensing unit for sensing an orientation of the remote controller; and a wireless transmitter for transmitting to the controlled system information as to which of the one or more keys is selected by the user and orientation information of the remote controller sensed by the sensing unit. The processing unit generates a control command for the controlled system in accordance with information about key selection by the user and orientation information of the remote controller, so as to control movement of a controlled object corresponding to the selected key in accordance with the orientation of the remote controller.

According to an embodiment of the present invention, each of said one or more keys corresponds to movement of a controlled unit of the controlled system.

According to an embodiment of the present invention, the controlled system is an X-ray system, and said one or more keys include at least one of the following: a key for increasing or decreasing a collimator window view, a key for moving an X-ray bulb tube hanger upward or downward, a key for moving an X-ray bulb tube hanger left or right, a key for moving an X-ray bulb tube hanger forward or backward, a key for rotating an X-ray bulb tube clockwise or counterclockwise, a key for increasing or decreasing a distance between an X-ray bulb tube and a sickbed detector, a key for ascending or descending a wall stand detector, a key for rotating a wall stand detector upward or downward, and a key for moving a sickbed detector left or right.

According to an embodiment of the present invention, said one or more keys further include at least one of the following: a key for automatic tracking of the system and a key for automatic positioning.

According to an embodiment of the present invention, the processing unit generates a control command to maintain consistency between movement of a controlled unit corresponding to the selected key and the orientation of the remote controller sensed by the sensing unit.

According to an embodiment of the present invention, the sensing unit includes a first sensing unit for sensing an orientation of the remote controller in a vertical direction.

According to an embodiment of the present invention, the sensing unit includes a second sensing unit for sensing an orientation of the remote controller in a horizontal direction.

According to an embodiment of the present invention, the first sensing unit is an accelerometer.

According to an embodiment of the present invention, the second sensing unit is a magnetometer.

According to an embodiment of the present invention, the first sensing unit senses an orientation of the remote controller in a vertical direction by sensing an included angle between a head portion of the remote controller and the vertical direction.

According to an embodiment of the present invention, said processing unit determines that the orientation of the remote controller is upward when said included angle is smaller than a first threshold value, and determines that the orientation of the remote controller is downward when said included angle is greater than a second threshold value, the first threshold value being smaller than the second threshold value.

According to an embodiment of the present invention, the second sensing unit senses an orientation of the remote controller in a horizontal direction by sensing an included angle formed between a head portion of the remote controller and a geomagnetic field direction in a reference plane.

According to an embodiment of the present invention, the processing unit determines an orientation of the remote controller in a horizontal direction in accordance with the included angle between a head portion of the remote controller and a geomagnetic field direction in a reference plane, and an included angle between a target controlled member to be controlled by the remote controller and a geomagnetic field direction in said reference plane.

According to another aspect of the present invention, there is provided a remote controller wirelessly communicating with a controlled system that is remotely controlled. The remote controller including: one or more keys, each corresponding to movement of a controlled unit of the controlled system, for a user to select a controlled object to be controlled via the remote controller; and a sensing unit for sensing an orientation of the remote controller.

According to an embodiment of the present invention, the remote controller further comprises a processing unit capable of generating a control command for the controlled system in accordance with information about key selection by the user and orientation information of the remote controller, so as to control movement of a controlled object corresponding to the selected key in accordance with the orientation of the remote controller.

According to an embodiment of the present invention, the remote controller further comprises a wireless transmitter for transmitting to the controlled system information as to which of the one or more keys is selected by the user and orientation information of the remote controller sensed by the sensing unit.

According to an embodiment of the present invention, the remote controller further comprises a wireless transmitter for transmitting the control command generated by the processing unit to the controlled system.

According to an embodiment of the present invention, the controlled system is an X-ray system, and said one or more keys include at least one of the following: a key for increasing or decreasing a collimator window view, a key for moving an X-ray bulb tube hanger upward or downward, a key for moving an X-ray bulb tube hanger left or right, a key for moving an X-ray bulb tube hanger forward or backward, a key for rotating an X-ray bulb tube clockwise or counterclockwise, a key for increasing or decreasing a distance between an X-ray bulb tube and a sickbed detector, a key for ascending or descending a wall stand detector, a key for rotating a wall stand detector upward or downward, and a key for moving a sickbed detector left or right.

According to an embodiment of the present invention, the processing unit generates a control command to maintain consistency between movement of a controlled unit corresponding to the selected key and the orientation of the remote controller sensed by the sensing unit.

According to another aspect of the present invention, there is also provided an X-ray system, comprising a remote controller as described above, and is used for controlling each controlled member of the X-ray system.

### BRIEF DESCRIPTION OF THE DRAWINGS

The present invention will be more apparent to those skilled in the art upon referring to the accompanying drawings, in which:

FIG. 1 is a schematic diagram of an X-ray system in accordance with one embodiment of the present invention;

FIG. 2 is a schematic diagram showing configuration of a remote controller according to an embodiment of the present invention;

FIG. 3 is a diagram showing how to determine an upward orientation of the remote controller according to an embodiment of the present invention;

FIG. 4 is a diagram showing how to determine a downward orientation of the remote controller according to an embodiment of the present invention; and

FIG. 5 is a diagram showing how to determine a horizontal direction of the remote controller according to an embodiment of the present invention.

### DESCRIPTION OF THE PREFERRED EMBODIMENTS

The present invention is detailed in terms of specific embodiments as the following, but the present invention is not limited to these embodiments. Although the following embodiments are illustrated by using a remote controller to control an X-ray system, persons skilled in the art could understand that the remote controller or remote control system of the present invention may be applied to any system which requires position and orientation adjustment by means of remote control.

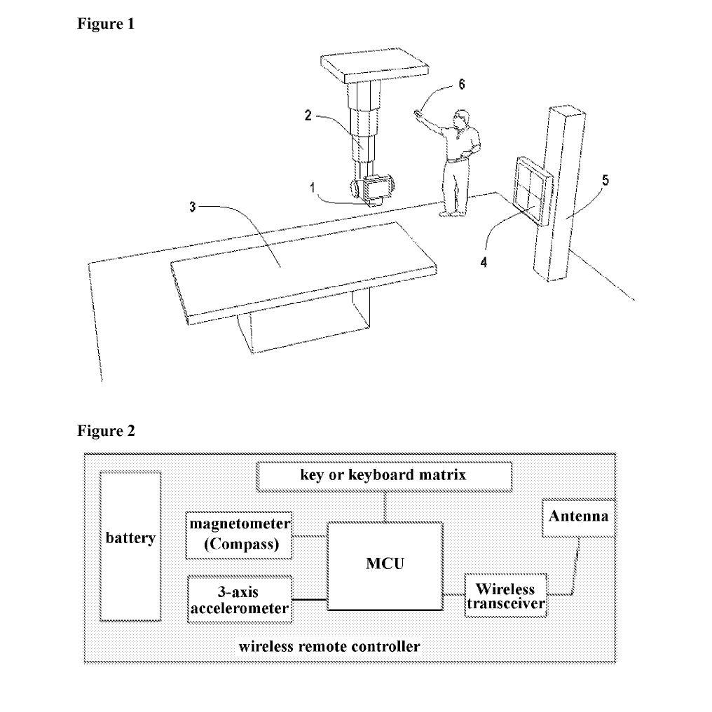

FIG. 1 is a schematic diagram of an X-ray system in accordance with one embodiment of the present invention. As shown in FIG. 1, the X-ray system in this embodiment includes an X-ray generator 1, such as a bulb tube, a bulb tube hanger 2 for suspending the bulb tube and adjusting the position thereof, a sickbed 3, a wall stand detector 4 for detecting an X-ray that has passed through an inspected object, and a post 5 for supporting the wall stand detector 4. FIG. 1 also shows a remote controller 6 handheld by the operator. The remote controller wirelessly communicates with various controlled members of the X-ray system for remote control. In addition, the X-ray system generally further includes a sickbed detector (not shown) underneath the sickbed 3. In the system shown in FIG. 1, by virtue of the remote controller 6, the operator can remotely control the bulb tube hanger 2 to initiate up and down, left and right, back and forth movement or rotation, remotely control the wall stand detector 4 or the post 5 to enable the wall stand detector 4 to move up and down or tilt upward or downward along the post, remotely control the sickbed 3 to move it left and right, and also can conduct remote control to increase or decrease the window view of the collimator of the bulb tube, or to increase or decrease the distance between the X-ray bulb tube and the sickbed detector, or the like.

FIG. 2 is a schematic diagram showing configuration of a remote controller according to an embodiment of the present invention. In the embodiment of FIG. 2, the wireless remote controller includes a key or keyboard matrix circuit corresponding to keys or a keyboard on the panel and sensing the user's keystrokes, a sensing unit for sensing an orientation of a head portion of the remote controller (a first sensing unit such as a 3-axis accelerometer for sensing a vertical orientation, and a second sensing unit such as a magnetometer for sensing a horizontal orientation in FIG. 2), a power supply (a battery in FIG. 2), an MCU (Micro Control Unit), a wireless transceiver, and an antenna.

According to an embodiment, the panel of the wireless remote controller is provided with one or more keys for the user to select a controlled object to be controlled by remote controller, each of said one or more keys corresponding to movement of a controlled unit of the controlled system. In the event that the controlled system is an X-ray system as shown in FIG. 1, said one or more keys include at least one of the following: a key for increasing or decreasing a collimator window view of the bulb tube, a key for moving an X-ray bulb tube hanger upward or downward, a key for moving an X-ray bulb tube hanger left or right, a key for moving an X-ray bulb tube hanger forward or backward, a key for rotating an X-ray bulb tube clockwise or counterclockwise, a key for increasing or decreasing a distance between an X-ray bulb tube and a sickbed detector, a key for ascending or descending a wall stand detector, a key for rotating a wall stand detector upward or downward, and a key for moving a sickbed detector left or right. In some embodiments, the panel of the wireless remote controller further comprises a key for automatic tracking of the system and a key for automatic positioning. The key for automatic tracking is used for controlling the X-ray bulb tube's automatic movement to a position in alignment with the wall stand X-ray detector or the sickbed detector, while the key for automatic positioning is used for controlling the automatic movement of the X-ray bulb tube and X-ray detector to an assigned position required for radiographing a patient in a posture (e.g., lying in bed, or standing). Optionally, the panel of the wireless remote controller may also include similar automatic control keys to improve convenience and efficiency of radiographers' operations.

When a user wishes to control the movement of a certain member of the X-ray system, the user points the remote controller generally at the X-ray system, and presses a key corresponding to the movement of said member, for example, a key for moving the X-ray bulb tube hanger upward or downward. Meanwhile, the user controls orientation of the head portion of the remote controller according to a desired moving direction of the controlled member. For example, if an upward movement of the X-ray bulb tube hanger is desired, the user can orient the head portion of the remote controller upward. Orientation of the remote controller can be sensed by way of a sensing unit (e.g., an accelerometer or a magnetometer) imbedded in the remote controller. The remote controller transmits to the processing unit of the remote control system information about which key is pressed by the user and orientation information of the remote controller, for the purpose of processing.

In one embodiment, the processing unit is located in a shared host of the controlled system, each controlled member (e.g., the X-ray bulb tube hanger, the radiographing bed, the wall stand, etc.) of the controlled system communicating with the shared host in a wired or wireless fashion. Each controlled member is internally provided with a suitable sensor (e.g., a position sensor, acceleration sensor, magnetometer, etc.), to acquire a motion pose, position and displacement respective thereof; sensing results of the sensor are transmitted to the shared host, such that the processing unit learns the real-time position and direction of each controlled member within the space coordinate system of the positioning system. The remote controller communicates with the shared host, transmitting thereto key information and spatial orientation data of the remote controller, and the shared host transfers said key information and spatial orientation data to the processing unit for processing. In one embodiment, the remote controller transmits to the processing unit in the controlled system information about key selection by the user and orientation information of the remote controller by way of a wireless transmitting device (e.g., a wireless transceiver and an antenna in FIG. 2). The processing unit determines a controlled object (i.e., movement of a corresponding controlled member) in accordance with key selection information, and generates a control command for controlling movement of the controlled object in accordance with orientation of the remote controller. In one embodiment, the processing unit generates a control command to maintain consistency between movement of a controlled member corresponding to the selected key and orientation of the remote controller sensed by the sensing unit. It will be understood that control commands may also be generated such that movement of the controlled member and the remote controller orientation are in other relationships (such as in a contrary relationship). The controlled member moves to reach a desired position and/or orientation according to the control command of the processing unit. In other embodiments, each of the controlled members of the controlled system may be provided with a respective processing unit. The processing unit of each of the controlled members receives information about a real-time position and orientation of said controlled member and remote controller data (which include, for example, key selection information and orientation information of the remote controller) for said controlled member, and upon processing, generates a control command for said controlled member, such that said controlled member performs a desired action under the control command, in order to complete a system function.

In another embodiment, the processing unit is located in the remote controller. For example, the processing unit is part of the MCU shown in FIG. 2. In such circumstance, the MCU determines a controlled object (movement of a corresponding controlled member) in accordance with key selection information, and generates a control command for controlling movement of the controlled object in accordance with orientation of the remote controller (e.g., for keeping consistency between movement of the controlled object and orientation of the remote controller). The remote controller transmits the control command to the controlled member of the controlled system by way of a wireless transmitting device (e.g., a wireless transceiver and an antenna in FIG. 2), such that the controlled member moves to reach a user desired position and/or orientation based on said control command.

In various embodiments as described above, the keys of the remote controller are provided to correspond to movement of controlled members, as opposed to the prior art, in which some keys correspond to a controlled member per se and some other keys correspond to a movement direction of the controller member. Further, in combination with said key arrangement, orientations of the remote controller may be adopted to replace moving direction keys. Through various embodiments as described above, the key layout of the remote controller can be simplified, such that remote control operations are made easier and less likely to be erroneous.

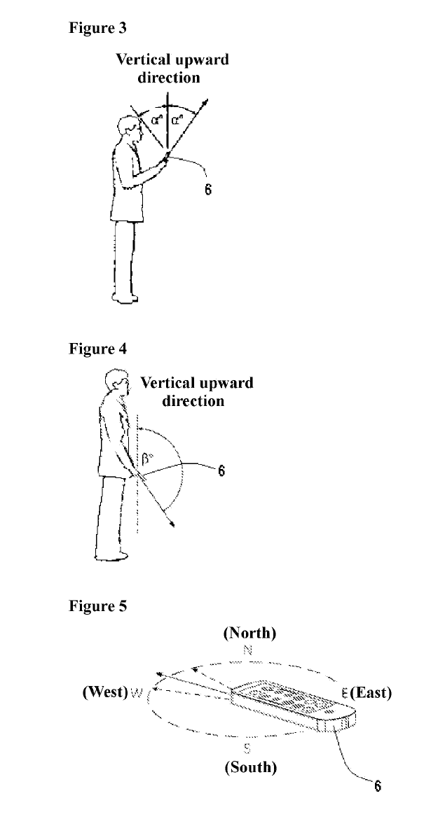

The following is to explicate the working principles for determining remote controller orientations according to an embodiment of the present invention with reference to FIGS. 3-5. As described above, according to one embodiment of the present invention, the remote controller can be embedded with one or more sensing units for sensing orientation information of the remote controller, for example, an accelerometer and a magnetometer as shown in FIG. 2. When the user operates the remote controller to be in a certain position and orientation, the accelerometer, as a first sensing unit, is capable of sensing an included angle between the head portion of the remote controller and a vertical upward direction at that time. The magnetometer, as a second sensing unit, is capable of sensing an included angle between the head portion of the remote controller and the geomagnetic field direction in a reference plane (for example, a plane where the horizontal plane of the sickbed is located, a plane where the ground surface on which the controlled system stands is located, etc.) at that time. The first and second sensing units transmit such angle information to the processing unit of the remote control system.

FIGS. 3-4 are diagrams showing how to determine an upward or downward orientation of the remote controller according to an embodiment of the present invention. In said figures, the angles α and β are threshold values preset by the user or system-default threshold values, α<β, and said values are stored in a memory associated with the processing unit. Upon receiving angle information transmitted by the sensing unit, the processing unit reads the stored α and β, and compare them with an included angle between the head portion of the remote controller and the vertical upward direction. When the included angle is smaller than α, the processing unit determines that the remote controller is oriented upward; when the included angle is greater than β, the processing unit determines that the remote controller is oriented downward.

FIG. 5 is a diagram showing how to determine a horizontal direction of the remote controller according to an embodiment of the present invention. First, the sensing unit, such as a magnetometer, calculates an included angle between the head portion of the remote controller and the geomagnetic field in a reference plane. Specifically, according to one embodiment, a plane where the horizontal plane of the sickbed is located, a plane where the ground surface on which the controlled system stands is located, or the like may serve as the reference plane. The memory associated with the processing unit stores real-time included angles formed between a target member (such as the X-ray bulb tube, the wall stand detector, the sickbed, the sickbed detector, and the like) and the geomagnetic field in said reference plane. Upon receiving an included angle of the remote controller sensed by the magnetometer, the processing unit compares this included angle to the included angle of the target member, to determine a horizontal orientation of the head portion of the remote controller relative to the target member. In one embodiment, based on the above two included angles, an included angle between the head portion of the remote controller and the target member can be calculated, based on which, a horizontal orientation of the head portion of the remote controller then can be determined. Similarly, one or more thresholds can be stored in advance in the memory, such that by comparing an included angle between the head portion of the remote controller and the target member to said one or more thresholds, a horizontal orientation of the head portion of the remote controller can be determined. For example, when the included angle between the head portion of the remote controller and a leftward direction along the front face (the side that the operator faces) of the target member is smaller than a first threshold value, the processing unit determines that the head portion of the remote controller is pointed at the left side (seen from the perspective of the operator); when the included angle between the head portion of the remote controller and a rightward direction along the front face (the side that the operator faces) of the target member is smaller than a second threshold value, the processing unit determines that the head portion of the remote controller is pointed at the right side (seen from the perspective of the operator); when the included angle between the head portion of the remote controller and a backward direction perpendicular to the front face (the side that the operator faces) of the target member is smaller than a third threshold value, the processing unit determines that the head portion of the remote controller is pointed at the rear side (seen from the perspective of the operator); when the included angle between the head portion of the remote controller and a forward direction perpendicular to the front face (the side that the operator faces) of the target member is smaller than a fourth threshold value, the processing unit determines that the head portion of the remote controller is pointed at the rear side (seen from the perspective of the operator). The first to the fourth threshold values can be partly or totally identical, or different from one another.

In these various embodiments with respect to FIG. 5, a horizontal plane is typically used as a reference plane in the calculation of an included angle between the head portion of the remote controller and the geomagnetic field. However, it should be understood that any other plane may serve as a reference plane, as long as said plane is also selected as a reference plane for calculating an included angle between the target member and the geomagnetic field.

In one embodiment, the target members in the controlled system such as an X-ray system each may include sensing units for sensing real-time positions thereof and/or sensing units for sensing their real-time orientations (for example, an included angle with the geomagnetic field). Such information about real-time positions and/or orientations, as sensed by these sensing units, are wiredly or wirelessly transmitted and stored in a memory associated with the processing unit for use in the next control operation.

Although the present invention has been described through specific embodiments in conjunction with the accompanying drawings, persons skilled in the art could make various changes, modifications and comparable substitutions without departing from the spirit and scope of the present invention, which changes, modifications and comparable substitutions are intended to be within the spirit and scope as defined by the appended claims.

What is claimed is:

1. A remote control system comprising:
a remote controller comprising:
at least one key for a user to select a controlled object to be controlled by the remote controller;
a sensing unit configured to sense an orientation of the remote controller; and
a wireless transmitter configured to transmit to a controlled system information of the at least one key selected by the user and orientation information of the remote controller sensed by the sensing unit; and
a processing unit located in the controlled system, wherein the processing unit is configured to generate a control command for the controlled system in accordance with the information of the at least one key selected by the user and the orientation information of the remote controller to control movement of the controlled object.

2. The remote control system according to claim 1, wherein each of the at least one key corresponds to movement of a controlled unit of the controlled system.

3. The remote control system according to claim 1, wherein the controlled system is an X-ray system, and wherein the at least one key comprises at least one of the following:
a key configure to increase or decrease a collimator window view;
a key configured to move an X-ray bulb tube hanger upward or downward;
a key configured to move the X-ray bulb tube hanger left or right;
a key configured to move the X-ray bulb tube hanger forward or backward;
a key configured to rotate the X-ray bulb tube clockwise or counterclockwise;
a key configured to increase or decrease a distance between the X-ray bulb tube and a sickbed detector;
a key configured to ascend or descend a wall stand detector;
a key configured to rotate the wall stand detector upward or downward; and/or
a key configured to move the sickbed detector left or right.

4. The remote control system according to claim 3, wherein the at least one key further comprises at least one of the following: a key configured to automatically track of the system, and a key configured to automatically position the system.

5. The remote control system according to claim 2, wherein the processing unit is further configured to generate a control command to maintain consistency between movement of the controlled unit corresponding to the at least one key selected by the user and the orientation of the remote controller sensed by the sensing unit.

6. The remote control system according to claim 1, wherein the sensing unit comprises a first sensing unit configured to sense the orientation of the remote controller in a vertical direction.

7. The remote control system according to claim 6, wherein the sensing unit further comprises a second sensing unit configured to sense the orientation of the remote controller in a horizontal direction.

8. The remote control system according to claim 6, wherein the first sensing unit is an accelerometer.

9. The remote control system according to claim 7, wherein the second sensing unit is a magnetometer.

10. The remote control system according to claim 6, wherein the first sensing unit senses the orientation of the remote controller in the vertical direction by sensing an included angle between a head portion of the remote controller and the vertical direction.

11. The remote control system according to claim 10, wherein the processing unit is further configured to determine the orientation of the remote controller is upward when the included angle is smaller than a first threshold value, and to determine the orientation of the remote controller is downward when the included angle is greater than a second threshold value, the first threshold value being smaller than the second threshold value.

12. The remote control system according to claim 7, wherein the second sensing unit senses the orientation of the remote controller in the horizontal direction by sensing an included angle formed between a head portion of the remote controller and a geomagnetic field direction in a reference plane.

13. The remote control system according to claim 12, wherein the processing unit is further configured to determine the orientation of the remote controller in the horizontal direction in accordance with the included angle between the head portion of the remote controller and the geomagnetic field direction in the reference plane, and the included angle between a target member to be controlled by the remote controller and a geomagnetic field direction in the reference plane.

14. A remote controller configured to wirelessly communicate with a controlled system that is remotely controlled, the remote controller comprising:
at least one key, each corresponding to movement of a controlled unit of the controlled system, and configured to allow a user to select a controlled object to be controlled by the remote controller; and
a sensing unit configured to sense an orientation of the remote controller.

15. The remote controller according to claim 14, further comprising:
a processing unit configured to generate a control command for the controlled system in accordance with information of the at least one key selected by the user and orientation information of the remote controller to control movement of the controlled object.

16. The remote controller according to claim 14, further comprising:
a wireless transmitter configured to transmit to the controlled system information of the at least one key selected by the user and orientation information of the remote controller sensed by the sensing unit.

17. The remote controller according to claim 15, further comprising:
a wireless transmitter configured to transmit the control command generated by the processing unit to the controlled system.

18. The remote controller according to claim 14, wherein the controlled system is an X-ray system, and wherein the at least one key comprises at least one of the following:
a key configured to increase or decrease a collimator window view;
a key configured to move an X-ray bulb tube hanger upward or downward;
a key configured to move the X-ray bulb tube hanger left or right;
a key configured to move the X-ray bulb tube hanger forward or backward;
a key configured to rotate the X-ray bulb tube clockwise or counterclockwise;
a key configured to increase or decrease a distance between the X-ray bulb tube and a sickbed detector;
a key configured to ascend or descend a wall stand detector;
a key configured to rotate the wall stand detector upward or downward; and/or
a key configured to move the sickbed detector left or right.

19. The remote controller according to claim 15, wherein the processing unit is further configured to generate a control command to maintain consistency between movement of the controlled unit corresponding to the at least one key selected by the user and the orientation of the remote controller sensed by the sensing unit.

20. An X-ray system, comprising:
a remote controller comprising:
at least one key, each corresponding to the movement of a controlled unit of the controlled system, and configured to allow a user to select a controlled object to be controlled by the remote controller; and
a sensing unit configured to sense an orientation of the remote controller; and
at least one controlled member,
wherein the remote controller is configured to control each controlled member of the X-ray system.
